(19) United States
(12) Patent Application Publication
(10) Pub. No.: US 2003/0122662 A1
(43) Pub. Date: Jul. 3, 2003

(54) Baby car seat alert and range alarm

(76) Inventor: David R. Quinonez, Fairfield, CA (US)

Correspondence Address: WILLIAM S. BERNHEIM, 255 N. Lincoln Street, Dixon, CA, 95620, US

(21) Appl. No.: 10/033,608

(22) Filed: Jan. 2, 2002

(51) Int. Cl. G08B 1/08

(52) U.S. Cl. 340/457; 340/573.1; 340/573.4

(57) ABSTRACT

An apparatus is provided for warning when a child has been left in a baby car seat and when one or both of: (i) a vehicle door has been opened, and (ii) a key ring remote unit is not within a predetermined zone about the vehicle. The apparatus includes a child detection mechanism for detecting the presence of a child within a baby car seat located within the vehicle; a door position detection mechanism for detecting the state of the driver side door of the vehicle; a range detection mechanism for detecting the range of a key ring remote from the vehicle; a control unit for generating an alarm signal when the child detection mechanism detects the presence of a child within the infant seat and either or both: (i) the door position detection mechanism detects that the state of the driver vehicle door position has been modified from a “closed” position to some other position, and (ii) the range detection mechanism detects that the key ring remote is no longer within the predetermined range from the vehicle; and alarm units for generating an alarm or alarms in response to the alarm signal.

### BACKGROUND OF THE INVENTION

1. Field of the Invention

This invention relates generally to baby car seats and a system for notifying responsible parties of the abandonment of a child within a vehicle.

2. Description of the Prior Art

Baby car seats are widely employed as a means of transporting children in vehicles. All too frequently, children transported in baby car seats are, for various reasons, left unattended within the vehicle in the respective baby car seat. Current regulations prohibit such practices. However, forgetful abandonment of children in baby car seats within vehicles continues to claim the lives of children. Accordingly, several means of notifying drivers that children have been abandoned in a baby car seat have been proposed. Examples of known systems are described in U.S. Pat. Nos. 5,581,234; 5,949,340; 5,966,070; and 6,104,293. Economically practical versions of known systems and apparatuses rely upon child occupant sensors that are likely to be activated by stimuli other than that invariably associated with a actual child. For example, weight or pressure sensors will activate if objects are placed purposefully or inadvertently in the unoccupied baby car seat. As a result, false alarms are common. Further aggravating this problem is that in the presence of a child “occupant” signal, existing systems are designed to activate an alarm if the vehicle ignition is turned to the “off” position, as may occur while waiting in a vehicle. Consequently, false alarms are not only common in present systems, but almost assured, resulting in the conditioning of drivers to ignore alarms indicative of children remaining unattended in a baby car seat within the vehicle. Drivers are thus likely to exit the vehicle conditioned to ignore alarm signals. Consequently, in a true alarm case additional thought is required on the part of the driver to realize that the alarm signal is actually indicative of an imminently abandoned child, essentially causing reliance upon the driver's memory, and nullifying the intended benefit of the system.

Further, none of the existing systems teaches a maximally reliable method of notifying the driver, once having departed the vehicle, of the need to return and remove the forgetfully abandoned child.

Therefore, it can be appreciated that there exists a continuing need for a new and improved system and apparatus for the safe transport and alarm-like warning of children remaining within baby car seats which eliminates the constancy of false alarms while providing for a maximally reliable monitor of a departing driver.

### SUMMARY OF THE INVENTION

In view of the foregoing disadvantages inherent in the known types of vehicle baby car seats and cooperative alarm systems and devices now present in the prior art, the baby car seat alert and range alarm of the present invention departs substantially from the conventional designs and concepts of the prior art. In doing so it provides an apparatus primarily developed for the purpose of permitting safe transport of children in baby car seats and a reliable alert in the event the child is abandoned in the vehicle via detection of a signal indicative of an exiting driver, or of the position of the driver excessively distant from the vehicle and entrapped child. As such, the general purpose of the present invention is to provide a baby car seat alert and alarm system which has all the advantages associated with combining the benefits of current baby car seats with the benefits of current baby car seat alarm systems, and has none of the disadvantages.

To attain this, the invention provides an apparatus for warning when a child has been left in a baby car seat and when one or both of: (i) a vehicle door has been opened, and (ii) a key ring remote unit is not within a predetermined zone about the vehicle. The apparatus includes a child detection mechanism for detecting the presence of a child within a baby car seat located within the vehicle; a door position detection mechanism for detecting the state of the driver side door of the vehicle; a range detection mechanism for detecting the range of a key ring remote from the vehicle; a control unit for generating an alarm signal when the child detection mechanism detects the presence of a child within the infant seat and either or both: (i) the door position detection mechanism detects that the state of the driver vehicle door position has been modified from a “closed” position to some other position, and (ii) the range detection mechanism detects that the key ring remote is no longer within the predetermined range from the vehicle; and alarm units for generating an alarm or alarms in response to the alarm signal.

It is an object of the present invention to provide an effective method and system for the secure transport of children seated within baby car seats disposed within vehicles that eliminates the likelihood of forgetful abandonment of a child within a vehicle.

It is a further object of the present invention to provide an effective method and system for the secure transport of children seated within baby car seats disposed within vehicles that increases the attention to a warning indicative of the abandonment of a child within a vehicle by decreasing the potential for the discount of such warning.

It is yet a further object of the present invention to provide an effective method and system for the secure transport of children seated within baby car seats disposed within vehicles that both eliminates the likelihood of forgetful abandonment of a child within a vehicle and increases the reliability of the alert system by employing dual means both for detection and warning notification of the departing driver.

It is yet a further object of the present invention to provide an effective method and system for the secure transport of children seated within baby car seats disposed within vehicles that detects the distance a driver has ventured from a child secured within the baby car seat.

It is yet a further object of the present invention to provide an effective method and system for the secure transport of children seated within baby car seats disposed within vehicles that sounds an alarm to alert the driver if the driver becomes removed a predetermined distance from the vehicle while a child is present within the baby car seat.

These and other objects and advantages will be apparent to those skilled in the art in light of the following disclosure, claims and accompanying drawings.

### BRIEF DESCRIPTION OF THE DRAWINGS

FIG. 1 is a perspective illustration of a baby car seat in accordance with the present invention.

FIG. 2 is a side view of a key ring remote in accordance with the present invention.

FIG. 3 is a block diagram illustrating the connection of a control unit to various components of the baby car seat of the present invention, including connection to components of the vehicle within which is disposed the baby car seat of FIG. 1, connection to components of the baby car seat of FIG. 1 and connection to components of the key ring remote of FIG. 2.

### DESCRIPTION OF THE PREFERRED EMBODIMENTS

FIG. 1 illustrates a baby car seat 10 in accordance with the present invention including a seat 12 and a safety harness 14. Baby car seat 10 may be designed for infants, toddlers, or other children as needed. Although not specifically illustrated, the baby car seat has a frame adapted to be fastened into place within an automobile in a conventional manner. Alternatively, the baby car seat may include a base unit fixedly attached to the vehicle and capable of cooperatively coupling to a seat unit including seat 12 and safety harness 14. In other embodiments, the baby car seat may be permanently affixed to the vehicle.

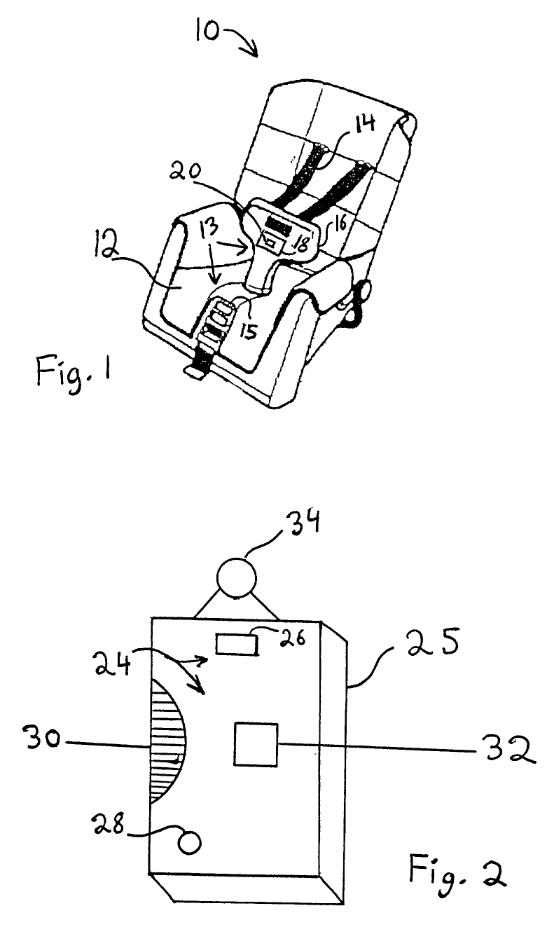

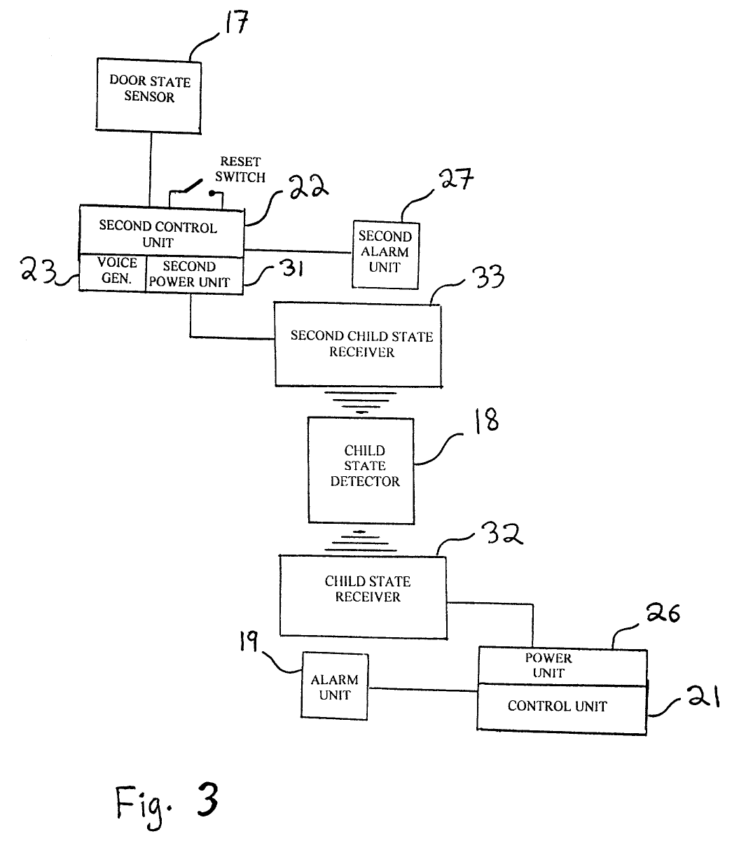

The baby car seat includes a buckle mechanism 13 having clasp 15 and buckle housing 16 incorporated into harness 14. A wireless child state detector 18 and is preferably incorporated into and located within or about buckle housing 16, although it may be located anywhere within or about the baby car seat 10 or the vehicle. Wireless child state detector 18 may include and employ any suitable means for detecting the presence of a child within a baby car seat. However, it is preferred that wireless child state detector 18 include an activation sensor designed and configured to detect the coupling of clasp 15 with buckle housing 16 into the locked, or “latched” position. Wireless child state detector 18 further includes a power source such as a battery (not shown) and a transmitter 20 (see also FIG. 3). Upon the coupling of clasp 15 with buckle housing 16 into the locked position wireless child state detector 18 generates a signal indicative of the presence of a child within baby car seat 10 that is sent by transmitter 20 to: (i) a control unit 21 located within key ring remote 25, and (ii) a second control unit 22 located within or about the dashboard of the vehicle, for which reference is made to FIGS. 2 and 3, respectively.

Shown in FIG. 2 is key ring remote 25 including an operations package 24. Key ring remote 25 is designed and configured to accomplish conventional purposes, such as locking the automobile or energizing the ignition. In addition, key ring remote 25 is designed and configured in accordance with the present invention. More specifically, operations package 24 includes control unit 21 (not shown), a power unit 26 having a battery with access door, one or more activation button(s) 28, an alarm unit 19 (not shown) powered by the battery with speaker 30, a transmitter and an wireless child state activation receiver 32 also powered by the battery. Further, control unit 21, and second control unit 22 (see FIG. 3) can be implemented utilizing programmed general purpose processors, application specific processors, firmware and discrete components or combinations thereof. Key ring remote 25 also includes key ring attachment 34 for connection to the automobile's ignition and door key ring.

As further referenced in FIG. 3, a second control unit 22 is preferably located underneath, within or otherwise about the dashboard of the vehicle within which is to be disposed the baby car seat 10 of the present invention. An onboard computer designed into the vehicle may, for example, perform the functions of second control unit 22. Alternatively, second control unit 22 may be provided with the baby car seat 10 of the present invention and designed to operate specifically with the baby car seat 10 of the present invention. If an after-market item, second control unit 22 may be affixed beneath or about the dash of the vehicle. In the preferred embodiment the second control unit 22 is provided beneath the dash of the vehicle and a second power unit 31 such as a battery power unit provides the power source. Thus, the car seat alert and range alarm of the present invention may be deployed into any automobile without requiring an integrated on board second control unit 22. The second control unit 22 is permanently in communication with a magnetically triggered door state sensor 17 provided with second control unit 22 and designed and configured to reliably monitor the state of the driver door of the vehicle. Specifically, when the driver side door is not in the closed position, the door state sensor 17 sends an “OPEN” signal via a “hard” wire connection to second control unit 22 so that second control unit 22 can detect whether the vehicle driver door is closed or not. However, in another embodiment an electrical connector may be used to couple second control unit 22 to the electrical system of the vehicle. In such embodiment, the electrical connector provides both power from the vehicle's battery and at least a door “OPEN” connection to second control unit 22.

The preferred embodiment illustrates a wireless connection between transmitter 20 of wireless child state detector 18 and control units 21 and 22, respectively. For example, sonic or RF may be suitably employed. In operation, baby car seat 10 is affixed within the vehicle and a child is appropriately placed and properly fastened to baby car seat 10 utilizing harness 14. When wireless child state detector 18 detects the coupling of clasp 15 with buckle housing 16 into the locked, or “latched” position, wireless child state detector 18 is activated to send periodic pulses to wireless child state activation receiver 32 of key ring remote 25, that provides a “LATCH” signal to control unit 21 indicating to control unit 21 that the baby car seat 10 is occupied by a child. Upon receiving the “LATCH” signal, control unit 21 must continue to receive the “LATCH” signal. If control unit 21 fails to receive the “LATCH” signal, the control unit 21, having sensed that the key ring remote is out of range, preferably activates its alarm unit 19 to energize speaker 30 with a distinct alarm sound. The Control unit is designed to fail to continue receiving the “LATCH” signal from wireless child state activation receiver 32 when, upon reaching the voyage destination, the driver exits and moves away from the vehicle, and the key ring remote is out of range. I.e. the key ring remote is removed at least a certain predetermined distance from wireless child state detector 18 of baby car seat 10. This may be accomplished by limiting the strength of the signal emitted by transmitter 20 and/or the signal threshold recognition capability of wireless child state activation receiver 32 necessary to activate and notify control unit 21 of a received “LATCH” signal. Thus, during the presence of key ring remote 25 within the vehicle, the “LATCH” signal from transmitter 20 is sufficiently strong to be detected by and activate wireless child state activation receiver 32. However, upon removal a predetermined distance from transmitter 20, i.e. becoming “out of range”, the “LATCH” signal generated by the forgetful abandonment of a child in baby car seat 10 is insufficiently strong or clear to be detected by and/or activate wireless child state activation receiver 32. At this point, control unit 21, having sensed that the predetermined range has been exceeded, generates an alarm to remind the vehicle driver that the child is still in the baby car seat. For example, the alarm unit 19 controlled by control unit 21 generates a loud panic alarm sound emitted from now energized speaker 30. Said predetermined range, which range is some distance outside the vehicle, may be for example two (2) meters.

Only by deliberate pushing of activation button(s) 28 a preordained number of times, or in a preordained sequence, can control unit 21 be stimulated to de-activate alarm unit 19 and speaker 30.

Simultaneously to wireless child state detector 18 sending periodic pulses via transmitter 20 to wireless child state activation receiver 32 coupled to control unit 21 of key ring remote 25, a second wireless child state activation receiver 33 coupled to second control unit 22 also receives the “LATCH” signal, indicating to second control unit 22 that the baby car seat 10 is occupied by a child. Upon reaching the destination, the driver will presumably open the driver door of the vehicle. At this point, second control unit 22, having sensed that the door is “OPEN”, preferably provides a signal to second alarm unit 27 to generate an alarm, thus reminding the driver to remove the child from the baby car seat. For example, voice generator 23 of second control unit 22 generates a message stating “CAUTION: REMOVE CHILD FROM VEHICLE”. However, if the driver, for any reason, ignores the warning, the panic alarm created by the driver taking out of range the key ring remote, as the driver will presumably retain the vehicle keys, will warningly again notify the driver that the child has been abandoned in the vehicle. Importantly, alarms are only generated when both the harness 14 is locked, or “latched, and also the door is open and/or the driver moves out of range from the vehicle, so that false alarms are actively avoided. Consequently, attention of the driver to the seriousness and validity of a received alarm signal is maintained. Resultantly, the foregoing objects of the present invention have been attained.

Although the present invention has been shown and described with respect to preferred embodiments thereof, it should be understood by those skilled in the art that various changes and omissions in the form and detail thereof may be made therein without departing from the spirit and scope of the invention as defined in the appended claims.

I claim:

1. An apparatus comprising:
(a) a child state detector for detecting the presence of a child within a baby car seat located within a vehicle;
(b) a component selected from a group consisting of:
(i) a door state sensor for detecting the state of a driver door of the vehicle and capable of being activated by an open driver door;
(ii) a range detector for detecting the distance of a driver possessing a key ring remote from the baby car seat located within the vehicle and capable of being activated by removing the key ring remote a predetermined distance from the child state detector;
(c) a control unit for generating an alarm signal when the selected component activates and provides a signal to the control unit; and
(d) a power unit for supplying electrical power to the control unit.

2. The apparatus of claim 1 wherein the selected component is the door state sensor.

3. The apparatus of claim 1 wherein the selected component is the range detector.

4. The range detector of claim 3 wherein the range detector further comprises the key ring remote.

5. The key ring remote of claim 4 wherein the key ring remote further comprises a wireless child state activation receiver.

6. The child state detector of claim 1 wherein the child state detector further comprises a wireless transmitter.

7. The child state detector of claim 6 wherein the child state detector couples to a harness of the baby car seat.

8. The child state detector of claim 6 wherein the wireless transmitter is capable of generating a signal receivable by a wireless child state activation receiver, the key ring remote including the wireless child state activation receiver.

9. The key ring remote of claim 8 wherein the wireless child state activation receiver is capable of discriminating the signal based upon predetermined criteria.

10. The wireless child state activation receiver of claim 9 wherein the predetermined criteria includes signal strength.
